(19) United States
(12) Patent Application Publication
(10) Pub. No.: US 2008/0317932 A1
(43) Pub. Date: Dec. 25, 2008

(54) GRAIN-BASED FOOD PRODUCT WITH TEMPERATURE-SENSITIVE INCLUSION

(75) Inventors: Carol Long, Palatine, IL (US); Eddie Lockhart, Carpentersville, IL (US); Marcus Parsons, Crystal Lake, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: THE QUAKER OATS COMPANY, Chicago, IL (US)

(21) Appl. No.: 11/767,762

(22) Filed: Jun. 25, 2007

(51) Int. Cl. A23L 1/10

(52) U.S. Cl. 426/618

(57) ABSTRACT

A food product with a temperature-sensitive inclusion, and a method of making the food product with the inclusion.

### FIELD OF THE INVENTION

The present invention relates generally to food products, and more particularly to grain-based products having a temperature-sensitive inclusion incorporated within.

### BACKGROUND OF THE INVENTION

For many years, grain-based food products have been a staple of the human diet. Popular grain-based food products include, for example, granola bars, breakfast bars, cereal bars, ready-to-eat cereal, and grain cakes such as rice cakes, corn cakes and popcorn cakes. The nutritional value and health benefits of grain-based food products are well-known and recognized. For example, consumption of oats has been shown to reduce total cholesterol concentration in the consumer's bloodstream, which can decrease the probability of heart diseases or heart attacks.

To improve the appeal of grain based food products to a broad range of customers, manufacturers have developed grain-based products having a wide range of shapes, flavors, colors, nutritional values, textures, and forms. For example, chocolate is coated onto the surface of the cereal clusters after they are formed and oven-dried. Also, attractive food inclusions can be incorporated on the surface of such food products to improve their appearance.

Ready-to-eat cereal, for example, can contain oat-based clusters with chocolate incorporated therein. One problem encountered is that the process temperatures for making such food products are typically incompatible with the heat-sensitive nature of such food inclusions. Chocolate, for example, melts at temperatures above about 30° C. Elevated process temperatures typically found in conventional processes will cause chocolate chips to melt and commingle with the food product, losing their visible distinct shapes. The types of food design and textures that can be achieved by such processes are thereby limited.

There is a need to provide an improved process for incorporating temperature-sensitive inclusions into grain-based food products that maintains the integrity of such inclusions.

### SUMMARY OF THE INVENTION

The invention relates to a food product having temperature-sensitive inclusions.

### DETAILED DESCRIPTION OF THE INVENTION

The invention relates to a food product comprising a grain-based component and a temperature-sensitive inclusion. In one embodiment, the grain-based component is combined with a binding agent and subjected to ambient cooling. The temperature-sensitive particles are then gently incorporated into the wet mix after it is removed from the mixing vessel. In another embodiment, the particles are introduced into the mixing vessel after the binding agent is thoroughly mixed with the grain-based component and cooled. Other ingredients, such as sweeteners, flavorings, colorings, vitamins, minerals, milk solids, dietary fiber, preservatives, and sugar such as sucrose, fructose, corn syrup and corn syrup solids, and mixtures thereof, can be added as desired. The final food products include, but are not limited to, grain-based clusters, bars or other types of agglomerates.

The grain-based component comprises, for example, cereal, oats, rice, corn grits, wheat grits, barley, granola, corn, potato, tapioca, starch extrudates, wheat, buckwheat, millet, rye or a combination thereof (e.g., multi-grain), in dry form. The grains may optionally be pre-processed by any method known to those skilled in the art to render it acceptable for consumption. Pre-processing includes, for example, flaking, dehulling, cooking, roasting, grinding, pregelatinizing, puffing, extrusion, crisping, and combinations thereof. Thus, the grain-based component can take many forms and often is in the form of a grain or portion thereof (such as rolled oats), a flake, flour, a puffed grain, an extrusion, a crisped grain, and other common forms.

The amount of grain-based component in the food product is preferably sufficient to form and maintain the desired shape. The amount used varies depending on, for example, the type of grains used, the type of pre-processing the grains are subjected to, and the desired flavor and textural characteristics. The total amount of grain-based component will typically be in the range of about 50 to about 80 wt %, preferably about 55 to about 75 wt %, and more preferably about 60 to 70 wt % based on the total weight of the final food product.

The binding agent typically comprises any binding agent capable of providing sufficient adhesion to the food product to form and retain the desired shape. Preferably, the binding agent imparts minimal moisture to the food product. The moisture content of the binding agent typically ranges from about 19 to about 30 wt %, more preferably from about 20 to about 25 wt %. The blended binding agent and mix typically is dried at temperatures of about 90 to about 235° C. (about 200 to about 450° F.), and more preferably at about 150 to about 205° C. (about 300 to 400° F.).

The binding agent can comprise a single ingredient or a mixture of ingredients. Suitable binding agents include, but are not limited to, aqueous sugar solution, sugar syrup, corn syrup, high fructose corn syrup, fructose syrup, corn syrup solids, shortening, honey, brown sugar, and mixtures thereof. Often, combination binding agents comprise between about 57 and about 65 wt % granulated white sugar in aqueous solution; between about 1 and about 5 wt % corn syrup solids; between about 3 and about 7 wt % honey; and between about 3 and about 7 wt % coconut oil. A particular example of a combination binding agent that can be used in accordance with the present invention is a syrup that comprises, granulated white sugar in aqueous solution, about 62 wt %; corn syrup solids, about 3 wt %; honey, about 5 wt %; and coconut oil, about 5 wt %. The syrup may optionally contain flavoring agents, such as brown sugar, peanut butter, raisin juice concentrate, coconut flavor, chocolate, chocolate flavor, and mixtures thereof.

Other optional additional ingredients that may be added include colorants, emulsifiers, and softening agents. Any food grade colorants familiar to the skilled practitioner are suitable. Colors may be used in combination to achieve a desired result. Similarly, emulsifiers such as mono- and diglycerides, lecithin, and distilled monoglycerides, and other emulsifiers known to the skilled practitioner can be used. Softening agents, known to the skilled practitioner, including glycerine, oils, and sugar alcohols can be used. The skilled practitioner also recognizes that a compound potentially may have two functions. For example, glycerine is known to the skilled practitioner as both a softening agent and as a humectant. With the guidance provided herein, the skilled practitioner can select optional additions suitably for use to make a flavorful, shelf-stable product.

The amount of binding agent used is that amount necessary to provide sufficient adhesion to allow the food product to be formed into a desired shape and to maintain that shape. This will depend on the type of binding agent used. Typically, the amount of binding agent used is about 20 wt % to about 50 wt %, preferably about 25 wt % to about 45 wt %, and more preferably about 30 wt % to about 40 wt %, based on the total weight of the wet food product. Therefore, the moisture content of the wet food product (i.e., before drying) will be in the range of about 8 to about 20 wt %, more typically between about 11% wt and about 17 wt %, based on the weight of the wet food product.

The temperature-sensitive inclusion can be selected from any known edible food material that tends to melt, liquefy or deform at temperatures greater than about 30° C. Examples of temperature-sensitive inclusions include, but are not limited to, chocolate chips, chocolate- or yogurt-compound coating, cheese, dairy products, fruit pieces, nougat, gum, and mixtures thereof. In accordance with the invention, the original identity of the temperature-sensitive inclusion is substantially maintained even after processing. Preferably, the temperature-sensitive inclusion does not co-mingle with the grain-based inclusion, but remains as discrete pieces. For example, chocolate chips remain as visible discrete pieces in the final food product.

The size of the temperature-sensitive inclusion typically is established at the size that yields about 10,000-about 12,000 pieces per pound, depending on the density of the pieces. For chocolate pieces, which typically are formed in the shape of a “chocolate chip”, i.e., an approximately pear-shaped drop with a flat, essentially circular bottom, the diameter of the bottom typically would be between about 1 and about 10 mm, and more typically between about 3 and about 5 mm. The skilled practitioner recognizes that sizes smaller than these often become subsumed by or melt into the binder and cease to be separately identifiable inclusions. Similarly, sizes larger than these typical sizes may make it difficult to incorporate the inclusions into the binder or onto the wet product during processing. Chocolate pieces having about 10,000 to about 12,000 pieces per pound are commercially available from, for example, Barry-Callebaut, Blommer Chocolate Company, Guittard, and Wilbur Chocolate Company, and from many other commercial suppliers.

The amount of temperature-sensitive inclusion in the food product varies depending on the type of food material used and the desired food product design. For example, in the embodiment in which chocolate chips are used, the amount of chocolate chips typically comprises about 5% to about 40 wt %, and more typically about 10% to about 20 wt %, based on the total weight of the final food product.

It is an advantage of the present invention that the visual appearance and texture of the temperature-sensitive inclusion, like that of distinct chocolate pieces or chips, is retained in the final food product. This provides greater flexibility in food product design. For example, granola clusters with visible pieces of chocolate incorporated therein can now be produced in accordance with the invention. Such clusters can be formed into any shape, or can be formed into amorphous shapes or random chunks.

In accordance with one embodiment of the invention, the inclusions are blended into a cooled mixture of binder and substrate. In another embodiment, a mixture of binder and substrate is laid out on a continuous belt and cools naturally. The inclusions are applied to the surface of the cooled wet product on the belt and gently embedded into the cooled product.

In accordance with these embodiments of the invention, a wet mix first is prepared. Wet mix is formed by combining a substrate with the binding agent. Substrate, also known as dry mix, comprises the grain-based component, and can include multiple types of grain components. The wet mix can be obtained by any method known to one skilled in the art. In one embodiment, the dry mix and the binding agent, together with any optional ingredients, are combined in a mixing vessel and mixed for a time sufficient to obtain a substantially uniform intermixing of the individual ingredients. Examples of ways in which the mixing action can be achieved include, but are not limited to, hand mixing with a spoon, a continuous solid flight twin screw mixer, a tumbler or enrober, a ribbon mixer, a paddle mixer, a dough mixer and a dual blade mixer. Alternatively, the grain-based component can be sprayed with the binding agent, or immersed in the binding agent.

The binding agent is essentially solid at ambient temperature after drying. Before drying, the binding agent is liquid at temperatures above about the melting point of the temperature-sensitive inclusion. However, the binding agent typically is heated to a temperature of between about 50° C. to about 85° C., and more preferably from about 60° C. to about 70° C., before combining it with the grain-based component. This is to ensure that the binding agent has an acceptable viscosity for mixing. The skilled practitioner recognizes that the viscosity of the binding agents typically decreases as the temperature increases. Thus, the temperature is raised to a point that enables mixing yet is not so high as to cause thermal degradation (such as carmelization or burning). The mixing is typically carried out for about 1 to about 8 minutes, and more preferably about 2 to about 4 minutes, to provide for a substantially uniform mixture of binding agent and the grain-based component.

In accordance with the first embodiment, after the dry mix and binding agent are combined, the resultant wet mix is cooled before adding the temperature-sensitive inclusion. The cooling step preferably prevents the temperature-sensitive inclusion from substantially melting and losing its distinct shape upon being incorporated into the wet mix. The wet mix preferably is cooled to a temperature below the melting point of the temperature-sensitive inclusion, but not so low as to make the cooled wet mix plus inclusions no longer malleable. For example, in the case of chocolate chips being used as the temperature-sensitive inclusion, the wet mix is cooled to about 20 to about 30° C. Cooling can be achieved, for example, by adding dry ice to the mixer while continuing to mix the product gently, or by passing the wet mix through a refrigerated compartment or over a refrigerated surface.

After the wet mix is cooled, the temperature-sensitive inclusion is added to the wet mix. The temperature-sensitive inclusion is preferably added or metered in very quickly to minimize its exposure with the wet mix while it may be warm enough to melt small quantities of the inclusions, i.e., the temperature-sensitive inclusion. This will advantageously reduce the degree of melting in the temperature-sensitive inclusion. The inclusions also can be refrigerated to improve their resistance to melting. More preferably, agitation of the resulting mixture is minimized to prevent the temperature-sensitive inclusion, which may be slightly melted, from intermingling with the grain-based component and thereby losing its distinct shapes. Agitation can be minimized by, for example, minimizing the duration and speed of mixing. The air temperature is preferably maintained at about 10 to about 21° C. (about 50 to about 70° F.), and more preferably between about 15 to 18° C. (about 60 to 65° F.). The relative humidity of the air is preferably about 55 to 65%. The skilled practitioner recognizes that precautions against high humidity typically are used when chocolate forms part of a food product. Thus, when the inclusion is chocolate, the relative humidity of the cool air is controlled. Different inclusions may require different relative humidities, which conditions are known to the skilled practitioner.

In this embodiment, the temperature-sensitive inclusion is combined with the wet mix by mixing the ingredients for a very short period of time. Examples of methods useful for combining the temperature-sensitive inclusion with the wet mix include, but are not limited to, blending the ingredients in a mixing vessel using mechanical means (e.g., ribbon mixer, a paddle mixer, a dough mixer, or a dual blade mixer) or manually by hand using a spoon. Typically, a dough mixer at relatively low rotation speeds is preferred for these mixing steps.

The mixing is preferably sufficiently gentle to prevent the temperature-sensitive inclusion from deforming and losing its shape while achieving substantially uniform distribution. The duration of mixing depends on the amount and type of components used. Typically, the time for adding and blending the temperature-sensitive inclusion is up to about 3 minutes, and more typically about 1 to about 2 minutes is adequate to achieve sufficient mixing.

After mixing, the resulting mixture is spread out on a surface in the form of a slab, such as a non-stick pan or continuous belt. The width of a slab generally will be established by the size of the continuous belt equipment on which it is made, and the width and length will be fixed if a pan is used. However, the thickness of the slab formed is related to whether the forming slab or pan is perforated. The skilled practitioner recognizes that a perforated surface allows formation of a relatively thicker product than does a solid surface because the drying atmosphere can circulate on both sides of the product slab. Thus, the thickness of the product slab formed for the purpose of drying the product can be, for example, between about 0.3 to about 0.6 inch on a solid surface, but between about 0.5 to 2 inches on a perforated surface. As the skilled practitioner recognizes, the slab may be pressed slightly to ensure uniformity of thickness. With the information provided herein, the skilled practitioner will be able to determine a thickness suitable for a particular application.

In the second embodiment described above, the wet mix is first spread out on a surface (e.g. non-stick pan or continuous belt) in the form of a slab before gently incorporating the temperature-sensitive inclusion into the slab. This allows the slab to cool further before the addition of the temperature-sensitive inclusion. In addition, agitation can be minimized, since little blending is conducted. Rather, the inclusion pieces are gently mixed into the cooled slab with a force sufficient to ensure that the inclusion pieces are retained by the binder.

The incorporation of the inclusion pieces into the slab can be done in any manner suitable. In one embodiment, the temperature-sensitive inclusion pieces are continuously mixed into the cool slab with a rotating rake mounted above the conveyer. The rake is made of tines or fingers affixed to a shaft mounted above the slab perpendicular to the direction of the travel of the slab. The shaft rotates in the same direction the slab is moving. The tines thus rotate in a plane perpendicular to the surface of the moving slab and press the inclusions into the slab as it moves. In another method, for example, a roller or belt that engages the top surface of the product slab with force sufficient to press the inclusion pieces gently but firmly into the product may be used. Other methods, including hand pressing or use of mechanical “fingers”, to gently incorporate the inclusion pieces into the slab, also are suitable. With the guidance herein, the skilled practitioner will be able to determine appropriate temperatures. It is preferable to minimize movement of the slab during the processing. With the information provided herein, the skilled practitioner will be able to accomplish this step.

After the temperature-sensitive inclusion is added, the resulting slab is dried and cooled. The degree of drying depends on the desired properties of the final food product. For example, a food product formed from undried combined ingredients will tend to have a chewy texture, whereas a food product formed from dried ingredients will tend to have a crunchy texture.

In an embodiment, the resulting slab is dried to a moisture content of less than about 3.5% by weight, preferably less than about 3% by weight, and more preferably less than about 2.75% by weight. The drying can be achieved by any method known to one skilled in the art, including oven, vacuum/oven, and microwave. An indirect hot air drier, i.e., a drier in which hot air is circulated around the drying product, is preferred to a direct drier, wherein a heat source, such as a flame or a radiant heating coil, is directed at the product. The temperature for drying is typically about 150 to about 205° C. (about 300 to 400° F.). The dried slab is then cooled in a cooling tunnel for a time sufficient to being the temperature of the product down to a temperature sufficient to prevent re-agglomeration of the product after it is broken into discrete pieces. Typically, for a product containing chocolate, a temperature less than about 30° C., (about 86° F.), more typically less than about 25° C. (about 77° F.), and even more typically less than about 21° C. (about 70° F.), is used. At temperatures at and below these values, the temperature-sensitive inclusion, which may be partially melted, will resolidify and form distinct shapes.

After the slab is sufficiently cooled, the resulting slab is shaped to form the desired food product. In one embodiment, the slab is broken up to form clusters or agglomerates. A breaker roll or lump breaker, rakes, forks, plows or any other suitable equipment can be used to break up the slab. For example, for a ready-to-eat cereal product, or a snack product, such as granola, the slab is broken into irregular shapes having dimensions less than about 1 inch, and typically between about ¼″ and about ¾″, more typically between about ⅜″ and about ⅝″

After the shaping, the grain-based product can be packaged or post-processed to form the final food product. In one embodiment, the food product is bulk packaged in for example, flexible bags or HDPE containers. Various bulk packaging sizes or number of servings can be provided, depending on different factors such as consumer demands or marketing strategy.

The invention is further described, but not limited by, the following example.

### EXAMPLE 1

A dry mix comprising two types of flakes (81% by weight), whole grain flour (9% by weight), and a low density crisped grain (10% by weight) is blended at a weight ratio of 1.75/1 with a syrup and chocolate chips. The syrup consists of water (19% by weight), sugar (43% by weight), binders (8% by weight), oil (5% by weight) and additives (12% by weight). The syrup has a temperature of 63° C. when mixing begins. Mixing is carried out in a dough mixer for 1.6 minutes.

The temperature of the resulting wet mix is 33° C. The wet mix is spread onto a belt in air conditioned room. Thirteen parts of chocolate chips (10,000 per pound) are deposited on top of the wet mix slab. The chips are gently and quickly mixed into the slab by fingers on a metal rod above the slab. The rod rotates in the same direction as the belt moves.

The slab then is compressed slightly to a thickness of about 0.5 inches and is dried in an oven at temperatures between about 150° C. and about 205° C. for 35 minutes. The dried slab is cooled to about 21° C. in a cooler tunnel, then passes through a breaker roll and is broken into small cluster pieces containing visible pieces of real chocolate.

While the invention has been particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

1. A method for making a grain-based product comprising a temperature-sensitive inclusion having a melting point, said method comprising:
preparing a wet mix by admixing a grain-based substrate with a binder agent at a temperature above the melting point sufficient to liquefy the binder agent;
cooling the wet mix to a temperature approximately equal to about or less than the melting point to obtain a malleable wet mix;
adding a temperature-sensitive inclusion to the malleable wet mix with minimal agitation to form a wet mix comprising the inclusion;
forming a slab of the wet mix comprising the inclusion;
drying the slab to essentially solidify the binder agent;
cooling the dried slab to a temperature sufficient to prevent agglomeration after the slab is shaped; and
shaping the cooled slab to form pieces of the grain-based product comprising a temperature-sensitive inclusion that essentially retains its identity.

2. The method of claim 1 wherein the grain-based substrate is selected from the group consisting of cereal, oats, rice, corn grits, wheat grits, barley, granola, corn, potato, tapioca, starch extrudates, wheat, buckwheat, millet, rye, and blends thereof.

3. The method of claim 1 wherein the binder agent is selected from the group consisting of aqueous sugar solution, sugar syrup, corn syrup, high fructose corn syrup, fructose syrup, corn syrup solids, shortening, honey, brown sugar, and blends thereof.

4. The method of claim 1 wherein the temperature-sensitive inclusion is selected from the group consisting of chocolate chips, chocolate- or yogurt-compound coating, cheese, dairy products, fruit pieces, nougat, gum, and blends thereof.

5. The method of claim 4 wherein the temperature-sensitive inclusion comprises chocolate pieces having a size that yields about 10,000 to about 12,000 pieces per pound.

6. The method of claim 5 wherein the shaped pieces have dimensions less than about one inch.

7. A method for making a grain-based product comprising a temperature-sensitive inclusion having a melting point, said method comprising:
preparing a wet mix by admixing a grain-based substrate with a binder agent at a temperature above the melting point sufficient to liquefy the binder agent;
forming a slab of the wet mix;
cooling the slab to a temperature at which the slab is malleable and which is approximately equal to about or less than the melting point;
adding a temperature-sensitive inclusion to the cooled slab with minimal agitation;
drying the cooled slab to essentially solidify the binder agent;
cooling the dried slab to a temperature sufficient to prevent agglomeration after the slab is shaped; and
shaping the cooled slab to form the grain-based product comprising a temperature-sensitive inclusion that essentially retains its identity.

8. The method of claim 7 wherein the grain-based substrate is selected from the group consisting of cereal, oats, rice, corn grits, wheat grits, barley, granola, corn, potato, tapioca, starch extrudates, wheat, buckwheat, millet, rye, and blends thereof.

9. The method of claim 7 wherein the binder agent is selected from the group consisting of aqueous sugar solution, sugar syrup, corn syrup, high fructose corn syrup, fructose syrup, corn syrup solids, shortening, honey, brown sugar, and blends thereof.

10. The method of claim 7 wherein the temperature-sensitive inclusion is selected from the group consisting of chocolate chips, chocolate- or yogurt-compound coating, cheese, dairy products, fruit pieces, nougat, gum, and blends thereof.

11. The method of claim 10 wherein the temperature-sensitive inclusion comprises chocolate pieces having a size that yields about 10,000 to about 12,000 pieces per pound.

12. The method of claim 11 wherein the shaped pieces have dimensions less than about one inch.

13. A grain-based product comprising a temperature-sensitive inclusion that has maintained its identity in the product, the product comprises the dried combination of a grain-based substrate, a temperature-sensitive inclusion having a melting point, and a binder agent having a melting temperature above the melting point and which is essentially solid at ambient temperature after drying.

14. The product of claim 13 wherein the grain-based substrate is selected from the group consisting of cereal, oats, rice, corn grits, wheat grits, barley, granola, corn, potato, tapioca, starch extrudates, wheat, buckwheat, millet, rye, and blends thereof.

15. The product of claim 13 wherein the binder agent is selected from the group consisting of aqueous sugar solution, sugar syrup, corn syrup, high fructose corn syrup, fructose syrup, corn syrup solids, shortening, honey, brown sugar, and blends thereof.

16. The product of claim 13 wherein the temperature-sensitive inclusion is selected from the group consisting of chocolate chips, chocolate- or yogurt-compound coating, cheese, dairy products, fruit pieces, nougat, gum, and blends thereof.

17. The product of claim 16 wherein the temperature-sensitive inclusion comprises chocolate pieces having a size that yields about 10,000 to about 12,000 pieces per pound.

18. The product of claim 17 wherein the shapes pieces have dimensions less than about one inch.
